(19) United States
(12) Patent Application Publication
(10) Pub. No.: US 2011/0205663 A1
(43) Pub. Date: Aug. 25, 2011

(54) METHOD OF PRODUCING MAGNETIC STORAGE MEDIUM, MAGNETIC STORAGE MEDIUM AND INFORMATION STORAGE DEVICE

(75) Inventors: Kenji Sato, Kawasaki (JP); Tsutomu Tanaka, Kawasaki (JP); Takuya Uzumaki, Kawasaki (JP); Tsutomu Nishihashi, Susono (JP); Tadashi Morita, Tsukuba (JP); Kazuhiro Watanabe, Susono (JP)

(73) Assignee: ULVAC, INC., Chigasaki-shi, Kanagawa (JP)

(21) Appl. No.: 13/120,974

(22) PCT Filed: Sep. 30, 2009
(86) PCT No.: PCT/JP2009/067067

§ 371 Date: Apr. 27, 2011

(30) Foreign Application Priority Data
Oct. 3, 2008 (JP) 2008-258671

(51) Int. Cl. G11B 21/02; B05D 5/12; G11B 5/706

(52) U.S. Cl. 360/75; 427/131; 427/129; 428/848.2; G9B/21.003

(57) ABSTRACT

It is an object to produce a magnetic storage medium of a high recording density by a production method that does not impair mass productivity, and a magnetic storage medium 10 is produced by a production method including: a magnetic-film forming step of forming a magnetic film 61 on a substrate 62; and a dots separating step of reducing saturation magnetization by locally injecting mixed ions of N₂⁺ ion and N+ ion into an area, of the substrate 62, other than plural areas which respectively become magnetic dots 62c where information is to be magnetically recorded, thereby forming, between the magnetic dots 62c, a between-dot separator 62d having saturation magnetization smaller than saturation magnetization of the magnetic dots 62c.

### TECHNICAL FIELD

The present case relates to a method of producing a magnetic storage medium of a bit-patterned type, the magnetic storage medium of the bit-patterned type, and an information storage device including the magnetic storage medium of the bit-patterned type.

### BACKGROUND ART

Hard Disk Drives (HDD) have been in the mainstream of information storage device, as a mass-storage device capable of high-speed access and high-speed transfer of data. As to this HDD, the areal recording density has increased at a high annual rate so far, and a further improvement of the recording density is still desired even at present.

In order to improve the recording density of the HDD, it is necessary to reduce the track width or shorten the recording bit length, but when the track width is reduced, the so-called interference easily occurs between adjacent tracks. This interference is, namely, a generic name for a phenomenon in which a track next to a target track is overwritten with magnetic recording information at the time of recording, and a phenomenon in which crosstalk occurs due to a leakage magnetic field from a track next to a target track at the time of reproduction. Either of these phenomena becomes a factor that results in a drop in S/N ratio of reproducing signal, to cause deterioration in an error rate.

On the other hand, when the recording bit length is shortened, there occurs a thermal fluctuation phenomenon in which the performance of storing the recording bit for a long time decreases.

As a way of avoiding these interference and thermal fluctuation phenomenon and thereby realizing a short bit length or a high track density, a magnetic storage medium of a bit-patterned type is proposed (for example, see PTL 1). In this magnetic storage medium of the bit-patterned type, the position of a recording bit is predetermined, a dot made of a magnetic material is formed in the predetermined position of the recording bit, and a part between the dots is made of a non-magnetic material. When the dots made of the magnetic material are thus separated from each other, the magnetic interaction between the dots is small, and the above-described interference and thermal fluctuation phenomenon are evaded.

Here, as a method of producing the magnetic storage medium of the bit-patterned type, a conventional production method proposed in PTL 1 and the like will be described.

FIG. 1 is a diagram that illustrates the conventional production method of producing the magnetic storage medium of the bit-patterned type.

In the conventional production method, first, a magnetic film 2 is formed on a substrate 1 in a film-forming process (A).

Next, in a nano-imprint process (B), a resist 3 made of a UV curable resin is applied onto the magnetic film 2, a mold 4 having nano-sized holes 4a is mounted on the resist 3 so that the resist 3 enters the nano-sized holes 4a, thereby forming dots 3a of the resist 3, and the resist 3 is irradiated with ultraviolet light over the mold 4 so that the resist 3 is cured and the dots 3a are printed on the magnetic film 2. After the resist 3 is cured, the mold 4 is removed.

Subsequently, etching is performed in an etching process (C), so that the magnetic film is removed, while leaving magnetic dots 2a protected by the dots 3a of the resist 3. After the etching, the dots 3a of the resist 3 are removed by a chemical process, so that only the magnetic dots 2a remain on the substrate 1.

Afterwards, in a filling process (D), a part between the magnetic dots 2a is filled with a non-magnetic material and then, the surface is flattened in a flattening process (E), so that a magnetic storage medium 6 of the bit-patterned type is completed (F).

According to such a conventional production method, in order to stabilize the floating property of a magnetic head above the magnetic storage medium 6, the flattening with high accuracy is necessary in the flattening process (E). Therefore, there arise such a problem that a very complicated manufacturing process needs to be performed and such a problem that the manufacture cost increases.

As a way of avoiding these problems, there is proposed a processing method (ion doping system) of forming a separation state of dots by injecting ions into a magnetic film and thereby changing a magnetized state locally (for example, see PTL 2 and PTL 3). According to this ion doping system, the magnetic property is changed by injecting the ions and thus, complicated manufacturing processes such as the etching and the flattening are unnecessary, making it possible to suppress an increase in production cost to a large extent.

### CITATION LIST

### Patent Literature

PTL 1: Japanese Laid-open Patent Publication No. 3-022211
PTL 2: Japanese Laid-open Patent Publication No. 2002-288813
PTL 3: Japanese Laid-open Patent Publication No. 2003-203332

### SUMMARY OF INVENTION

### Technical Problem

However, in many of current ion doping systems, in order to avoid the above-described interference and thermal fluctuation phenomenon by effectively reducing saturation magnetization, a large amount of injection is required as the amount of injected ions. On the other hand, when a large amount of ions are injected at a time, damage to the surface of the magnetic film is huge. For this reason, in many of the current ion doping systems, in order to effectively reduce the saturation magnetization by suppressing such damage, an amount of ions controlled to some extent needs to be injected for a long time.

However, in recent years, magnetic storage media have been more and more desired to be produced in volume and manufacturability is required, and when the ion doping system is adopted in actual manufacturing, only a short time such as several seconds may be secured as the ion injecting time, and because of such circumstances, practical use has not been realized.

In view of the foregoing circumstances, it is an object of the present application to provide a method capable of producing a magnetic storage medium of a bit-patterned type without impairing mass productivity, and a magnetic storage medium and an information storage device which have a high recording density and may be produced by a production method that does not impair mass productivity.

### Technical Solution

According to a first basic mode of the invention, a method of producing a magnetic storage medium includes:

magnetic-film-forming including forming a magnetic film on a substrate; and
between-dots-separating including reducing saturation magnetization by locally injecting mixed ions of N₂⁺ ion and N⁺ ion into an area, of the magnetic film, other than a plurality of areas which respectively become magnetic dots where information is to be magnetically recorded, to form between the magnetic dots a between-dot separator having saturation magnetization smaller than saturation magnetization of the magnetic dots.

According to a second basic mode of the invention, a magnetic storage medium includes:

a substrate;

a plurality of magnetic dots which are provided on the substrate, each of which has a magnetic film and on each of which information is magnetically recorded; and

a between-dot separator that is provided between the magnetic dots, and that has a film which is structurally linked to the magnetic film of the magnetic dot continuously, into which mixed ions of N₂⁺ ion and N⁺ ion are injected and which has saturation magnetization smaller than saturation magnetization of the magnetic dot.

According to a third basic mode of the invention, an information storage device includes:

a magnetic storage medium including:
a substrate,
a plurality of magnetic dots which are provided on the substrate, each of which has a magnetic film and on each of which information is magnetically recorded, and
a between-dot separator that is provided between the magnetic dots, and that has a film which is structurally linked to the magnetic film of the magnetic dot continuously, into which mixed ions of N₂⁺ ion and N⁺ ion are injected into the film and which has saturation magnetization smaller than saturation magnetization of the magnetic dot;

a magnetic head that approaches or touches the magnetic storage medium, to perform at least one of magnetically recording of information and magnetically reproducing of information for the magnetic dot; and

a head-position control system that moves the magnetic head relatively with respect to a surface of the magnetic storage medium, to position the magnetic head on the magnetic dot for which at least one of the information writing and the information reproduction is performed by the magnetic head.

Because, according to the method of producing the magnetic storage medium, the magnetic storage medium and the information storage device in these basic modes, the between-dot separator is formed by the ion injection and thus, a complicated manufacturing process such as etching or filling is unnecessary, resulting in a simple production method. Further, the developer of the present case has found that the injection of the mixed ions of N2+ ion and N+ ion into the magnetic film makes it possible to effectively reduce the saturation magnetization with a smaller amount of injection than those previously known. As a result, it is possible to reduce the ion injecting time, and produce the magnetic storage medium of the bit-patterned type with a high recording density without impairing the mass productivity.

### Advantageous Effects

As described above, by the present invention, according to the basic mode of each of the method of producing the magnetic storage medium, the magnetic storage medium and the information storage device, a magnetic storage medium with a high recording density is realized by a production method that does not impair the mass productivity.

### BRIEF DESCRIPTION OF DRAWINGS

FIG. 1 is a diagram that illustrates a conventional production method of producing a magnetic storage medium of the bit-patterned type.

FIG. 2 is a diagram that illustrates an internal structure of a Hard Disk Device (HDD) that is an exemplary embodiment of the information storage device.

FIG. 3 is a perspective view that schematically illustrates a structure of the magnetic disk of the bit-patterned type.

FIG. 4 is a diagram that illustrates an exemplary embodiment of the method of producing the magnetic storage medium for which the basic mode has been described above.

FIG. 5 is a diagram that illustrates an example.

FIG. 6 is a graph indicating the coercive force of the ion injection in each of the examples, the first comparative example and the second comparative example.

FIG. 7 is a graph indicating the saturation magnetization of the ion injection in each of the examples, the first comparative example and the second comparative example.

### DESCRIPTION OF EMBODIMENTS

Exemplary embodiments of the method of producing the magnetic storage medium, the magnetic storage medium and the information storage device for which the basic modes have been described above will be described below with reference to the drawings.

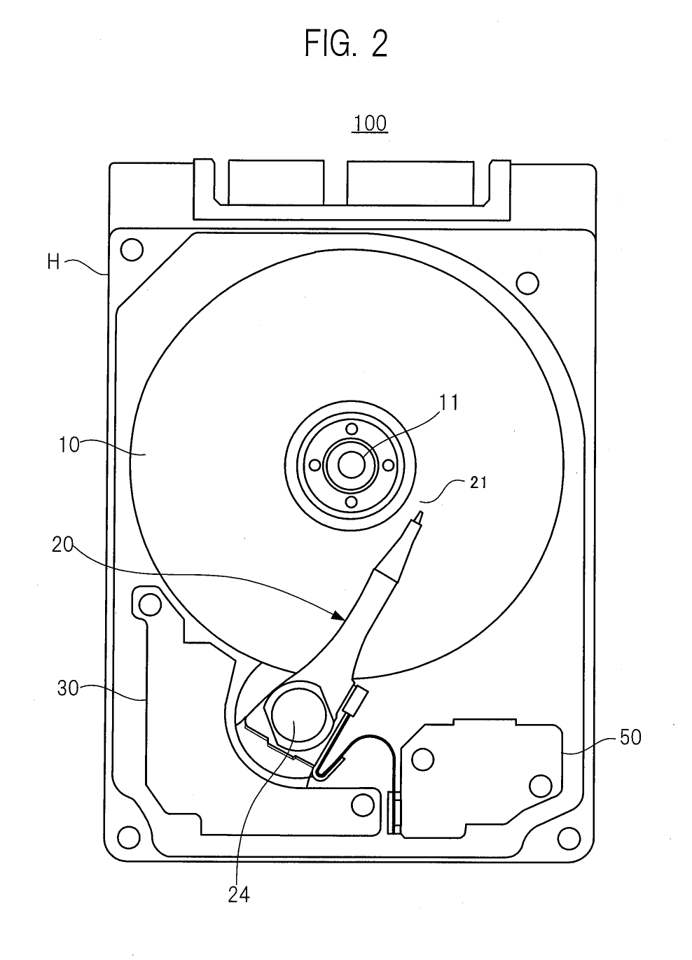

FIG. 2 is a diagram that illustrates an internal structure of a Hard Disk Device (HDD) that is an exemplary embodiment of the information storage device.

A Hard Disk Device (HDD) 100 illustrated in this diagram is incorporated into a host device such as a personal computer, and used as an information storage means in the host device.

In this hard disk device 100, two or more circular-plate-like magnetic disks 10, each of which is a so-called perpendicular magnetic storage medium in which information is recorded in the form of magnetic pattern by magnetization in a direction perpendicular to the front and back faces, are stacked in a depth direction of the diagram, and housed in a housing H. Further, each of these magnetic disks 10 is a so-called magnetic storage medium of a bit-patterned type in which a dot where bit information is to be recorded is formed beforehand at each point on the front and back faces. These magnetic disks 10 rotate about a disc spindle 11. These magnetic disks 10 are equivalent to an exemplary embodiment of the magnetic storage medium for which the basic mode has been described above.

Further, in the housing H of the hard disk device 100, a swing arm 20 that moves along the front and back faces of the magnetic disk 10, an actuator 30 used for driving the swing arm 20 and a control circuit 50 are also housed.

The swing arm 20 holds, at the tip, a magnetic head 21 that performs writing and reading of information to and from the front and back faces of the magnetic disk 10, is pivotably supported in the housing H by a bearing 24, and is pivoted within a predetermined angle range about the bearing 24, so that the magnetic head 21 is caused to move along the front and back faces of the magnetic disk 10. This magnetic head is equivalent to an example of the magnetic head in the above-described basic mode of the information storage device.

The reading and writing of information by the magnetic head 21 and the movement of the arm 30 are controlled by the control circuit 50, and the exchange of information with the host device also is performed through this control circuit 50. This control circuit 50 is equivalent to an example of the head-position control system in the above-described basic mode of the information storage device.

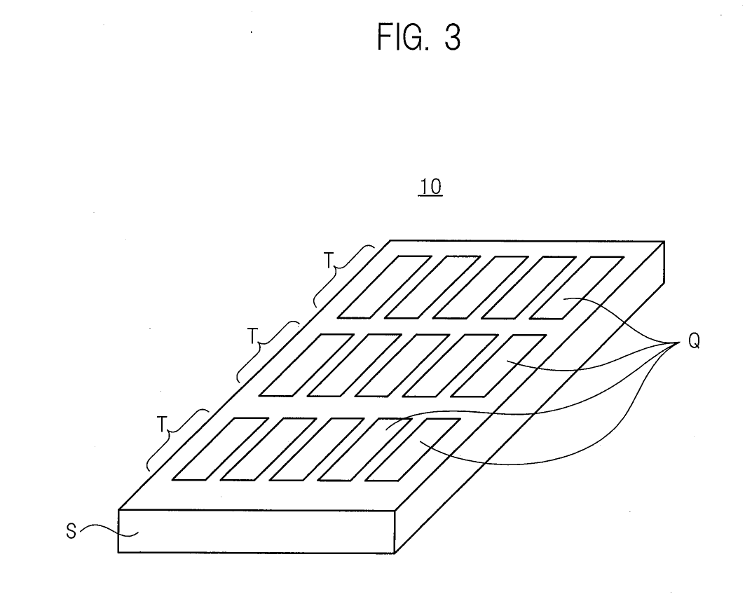

FIG. 3 is a perspective view that schematically illustrates a structure of the magnetic disk of the bit-patterned type.

In this FIG. 3, a part cut from the circular-plate-like magnetic disk is illustrated.

The magnetic disk 10 illustrated in FIG. 3 has such a structure that plural recording dots Q are regularly arranged on a substrate S, and information corresponding to 1 bit is magnetically recorded in each of the recording dots Q. The recording dots Q are arranged in like a circular orbit around the center of the magnetic disk 10, and a column of the recording dots forms a track T.

A part between the recording dots Q is a separator where the magnetic anisotropy and the saturation magnetization are lower than the magnetic anisotropy and the saturation magnetization of the recording dots Q and, the magnetic interaction between the recording dots Q is small due to this separator.

When the magnetic interaction between the recording dots Q is thus small, even at the time of recording and reproducing information to and from the recording dot Q, the magnetic interaction between the tracks T is small and thus, the so-called interference between the tracks is small. Further, when the position of the recording dot Q is thus fixed physically, the border of a recorded information bit does not fluctuate by heat, and the so-called thermal fluctuation phenomenon is evaded. Thus, according to the magnetic disk 10 of the bit-patterned type as illustrated in this FIG. 3, reduction of the track width and shortening of the recording bit length are possible, and the magnetic storage medium with a high recording density may be realized.

A method of producing this magnetic disk 10 will be described below.

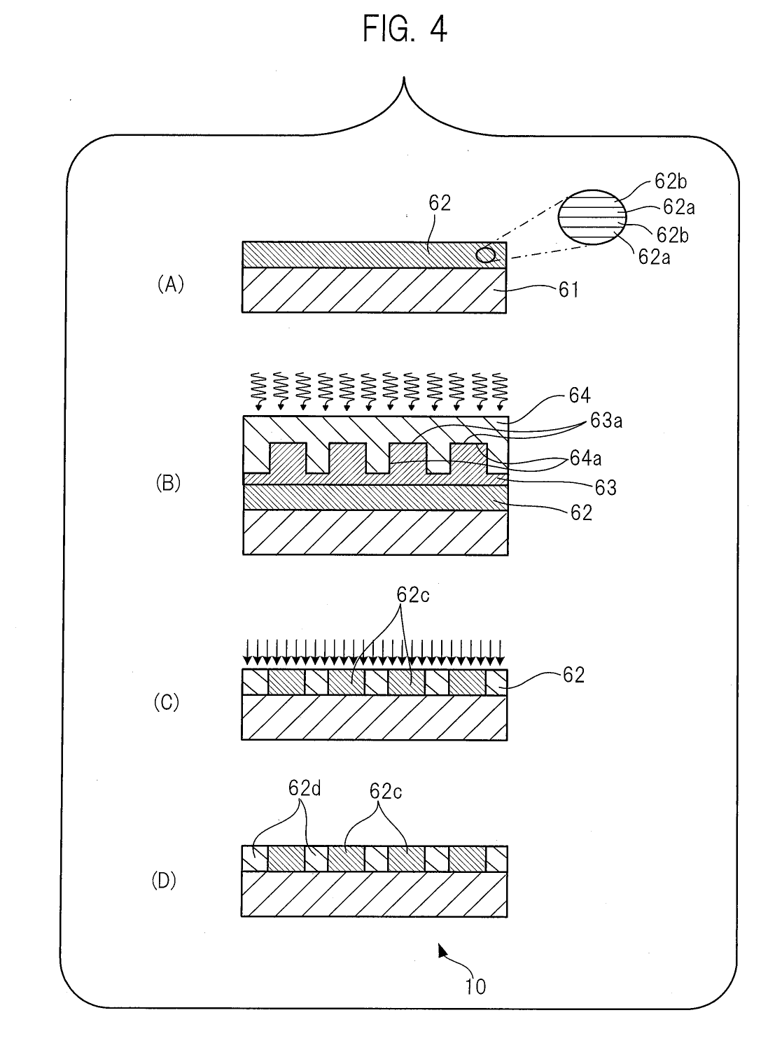

FIG. 4 is a diagram that illustrates an exemplary embodiment of the method of producing the magnetic storage medium for which the basic mode has been described above.

For the basic mode of the method of producing the magnetic storage medium, such an applied mode that “there is included a mask forming step of forming a mask that obstructs ion injection into the magnetic dots, on the plurality of areas which respectively become the magnetic dots,

in which the dots separating step is a step of applying the mixed ions from above the magnetic film where the mask is formed on the plurality of areas, thereby locally injecting the mixed ions into an area between the magnetic dots protected by the mask” is preferable. According to this applied mode, an area where the ion injection is unnecessary is reliably protected by the mask, and the accuracy of formation of the magnetic dot is high. One exemplary embodiment to be described below is also an exemplary embodiment for such a preferable applied mode.

Further, for the basic mode of the method of producing the magnetic storage medium, such an applied mode that “the magnetic-film forming step is a step of forming a magnetic film having an artificial lattice structure, by laminating plural kinds of atomic layers on the substrate alternately” is preferable. According to this applied mode, by making the magnetic film to have the artificial lattice structure, the effect of reducing the saturation magnetization by the ion injection may be enhanced and, the injecting time may be further shortened. One exemplary embodiment to be described below is an exemplary embodiment for such a preferable applied mode.

The magnetic disk 10 illustrated in FIG. 2 and FIG. 3 is produced by the production method illustrated in this FIG. 4.

In the production method illustrated in this FIG. 4, at first, a magnetic film 62 is formed on a glass substrate 61 in a film-forming process (A). This film-forming process (A) is equivalent to an example of the magnetic-film forming step in the above-described basic mode of the method of producing the magnetic storage medium, and this magnetic film 62 has an artificial lattice structure in which a Co atomic layer 62a and a Pd atomic layer 62b are laminated alternately. As for the film thickness structure of the Pd atomic layer 62b of the Co atomic layer 62a, the thickness of the Pd atomic layer 62b needs to be greater than the thickness of the Co atomic layer 62a to form the magnetic film 62. An upper limit to the film thickness of the Co atomic layer 62a is 2 nm, and this film thickness is equivalent to a thickness of about 7 atoms. When the Co atomic layer 62a has a film thickness beyond this upper limit, it is conceivable that a physical property that may be called an artificial lattice may be lost.

In the basic modes of the method of producing the magnetic storage medium, the magnetic storage medium and the information storage device, it is desirable that the artificial lattice structure be a structure in which a Co atomic layer and a platinum metal atomic layer are laminated alternately or a structure in which a Co atomic layer and a Pd atomic layer are laminated alternately. The reason is because the magnetic film of the artificial lattice structure in which the Co atomic layer and the platinum metal atomic layer are laminated alternately has a good magnetic property, and the magnetic property easily deteriorates due to the ion injection as will be described later, and because in a case of the magnetic film of the artificial lattice structure in which the Co atomic layer and the Pd atomic layer are laminated alternately, the magnetic property is better. The artificial lattice structure formed in the film-forming process (A) illustrated in this FIG. 4 is equivalent to an example of these preferable artificial lattice structures.

Incidentally, the magnetic film in the above-described basic modes is not limited to the one having the artificial lattice structure, and may be a magnetic film of a single layer.

Further, a material to form the magnetic film of the artificial lattice structure in the above-described applied mode of the type in which the magnetic film of the artificial lattice structure is formed is not limited to the preferable material described here, and any desired material known as being capable of forming the magnetic film having the artificial lattice structure may be used. However, in the following, the description will be continued assuming that the magnetic film is formed of Co and Pd.

Next, in a nano-imprint process (B), a resist 63 made of a UV curable resin is applied onto the magnetic film 62, a mold 64 having nano-sized holes 64a is mounted on the resist 63 so that the resist 63 enters the nano-sized holes 64a thereby becoming dots 63a of the resist 63, and the resist 63 is irradiated with ultraviolet light over the mold 64 so that the resist 63 is cured and the dots 63a are printed on the magnetic film 62. After the resist 63 is cured, the mold 64 is removed.

Here, for the above-described basic mode of the method of producing the magnetic storage medium, such an applied mode that the mask forming step is a step of forming the mask with a resist is preferable, and such an applied mode that the mask forming step is a step of forming the mask with a resist, by a nano-imprint process is more preferable. The mask formation by the resist is technically stable and may be expected to be accurate mask formation, and the mask formation by the nano-imprint process may easily make a mask pattern in a nano-level and is desirable. The nano-imprint process (B) illustrated in this FIG. 4 is equivalent to an example of the mask forming step in these preferable applied modes.

After the nano-imprint process (B), the flow advances to an ion injection process (C), where the dots 63a are irradiated from above the printed magnetic film 62 with mixed ions in which N2+ ion and N+ ion are mixed, and the ions are injected into the magnetic film 62 while magnetic dots 62c protected by the dots 63a of the resist 63 are left so that the saturation magnetization is reduced. The effect of reducing the saturation magnetization by the injection of the mixed ions of N₂⁺ ion and N⁺ ion is very high, as found by the developer of the present case at this time and further, the magnetic film 62 has the artificial lattice structure and therefore, the saturation magnetization of the magnetic film 62 may be reduced to a required level in a short time by the injection of the mixed ions here. This nano-imprint process (B) is equivalent to an example of the dots separating step in the above-described basic mode of the method of producing the magnetic storage medium.

Incidentally, in the above-described nano-imprint, the resist is not completely removed even in the area into which the ions should be injected, but the ions penetrate the resist at a location where the resist is thin and are injected into the magnetic film 62, whereas at a location where the resist is thick (namely, a location where the dots 63a are formed), the ions are stopped at the resist and do not reach the magnetic film and thus, it is possible to form a desired dot pattern. An ionic acceleration voltage is set so that the ions are injected into a central part of the magnetic film 62, but the set acceleration voltage varies depending on the depth to the central part of the magnetic film and the material. In the magnetic film 62 at the area into which the ions are thus injected, the ions are accumulated in the artificial lattice structure, the artificial lattice structure is warped, and a coercive force and the saturation magnetization fall. After the ion injection, the dots 63a of the resist are removed by a chemical process.

Through such an ion injection process (C), a separator 62d is formed between the magnetic dots 62c to separate the magnetic mutual interaction between the magnetic dots 62c, so that the magnetic storage medium 10 of the bit-patterned type is completed (D). In the separators 62d, the saturation magnetization is sufficiently lower than the saturation magnetization of the magnetic dots 62c and thus, information is recorded only in the magnetic dots 62c, while information is not recorded in the separators 62d.

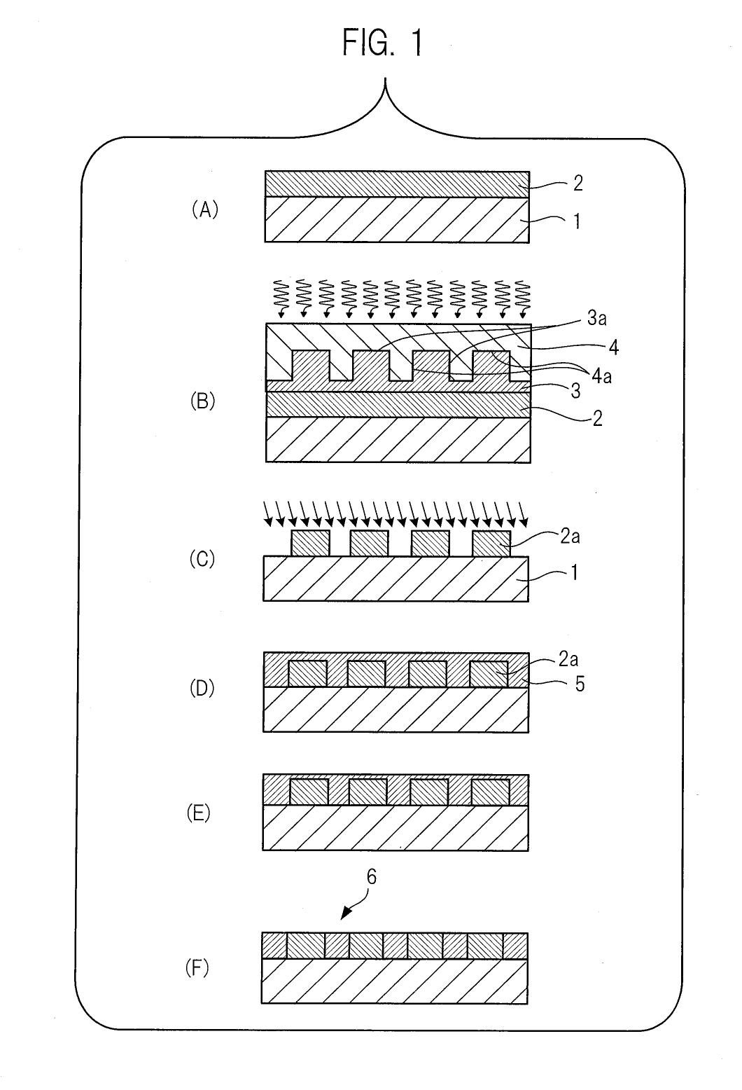

In the magnetic storage medium 10 produced in the production method illustrated in this FIG. 4, smoothness between the magnetic dots 62c and the separators 62d forming the surface is the smoothness in the magnetic film 62 formed in the film-forming process (A) which is maintained as it is and therefore, the flattening process of the conventional technique as illustrated in FIG. 1 is unnecessary, and the production method illustrated in this FIG. 4 is a simple method.

Further, in the production method illustrated in this FIG. 4, as described above, the mixed ions of N2+ ion and N+ ion producing a very high effect of reducing the saturation magnetization are adopted for the ion injection. For this reason, the amount of ions to be injected is small and thus, the injecting time is short, and the ion injection may be sufficiently realized by the ion irradiation for several seconds and therefore, the mass productivity is not impaired.

Furthermore, in the production method illustrated in this FIG. 4, the magnetic dots 62c are protected by the dots 63a of the resist printed on the magnetic film 62, and the entire surface of the magnetic storage medium 10 may be irradiated with the ions at a time, and the ion injection into the necessary area may be sufficiently realized by the ion irradiation for several seconds and thus, the mass productivity is not impaired in this respect as well.

In an example to be described below, the production method illustrated in this FIG. 4 is applied to specific materials and the like, and the technical effect was verified.

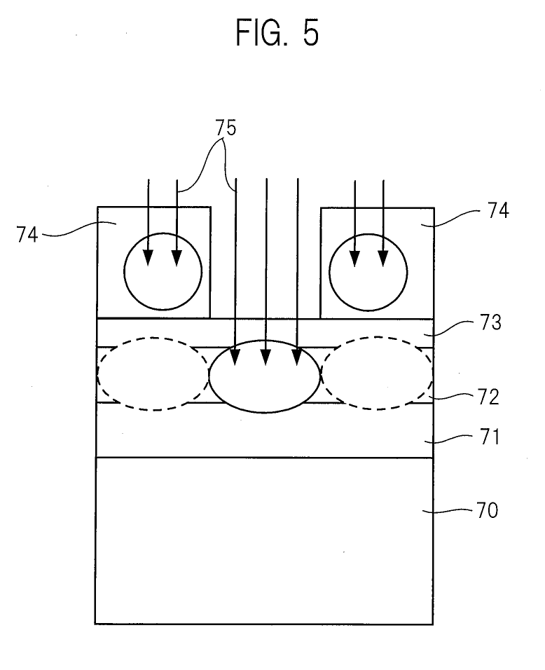

FIG. 5 is a diagram that illustrates the example.

A glass substrate 70 washed well was set in a magnetron sputtering device, and after evacuation to 5×10⁻⁵ Pa or less, at an Ar gas pressure of 0.67 Pa, without heating the glass substrate 70, a 5-nm-thick film of (111) crystal-oriented fcc-Pd was formed as a base layer 71 for making a magnetic layer have crystal orientation. As to the process for forming this base layer 71, the illustration is omitted in the production method depicted in FIG. 4.

Subsequently, successively without returning to the air pressure, at the Ar gas pressure of 0.67 Pa, a magnetic film 72 formed of a Co/Pd artificial lattice was repeatedly disposed to form eight layers in a film thickness structure of 0.3/0.35 nm. This film thickness structure refers to an artificial lattice in which a Co monoatomic layer and a PD monoatomic layer are repeated.

After the magnetic film 72 was formed, a 4-nm-thick film of diamond-like carbon was formed as a protective layer 73. The illustration of the process of forming this protective layer 73 also is omitted in the production method illustrated in FIG. 4.

A resist was applied onto the protective layer 73, and by using the nano-imprint process, a columnar resist pattern 74 having a diameter of 150 nm to 200 nm was formed.

Mixed ions 75 of N₂⁺ ion and N⁺ ion accelerated to 6 keV were emitted from above the resist pattern 74, and injected into the magnetic film 72. As described earlier, the ionic acceleration voltage was set to realize the ion injections into the central part of the magnetic film 72.

Incidentally, considering a realistic film thickness of the magnetic film and damage to the magnetic film at the time of the ion injection, it is desirable that the ionic acceleration voltage be 4 keV or more and 50 keV or less.

After the ion injection, the resist pattern 74 was removed by SCl cleaning, and thereby the example was obtained.

As comparative examples to be compared with the above-described example, a first comparative example in which only N⁺ ion was used as the type of ion and a second comparative example in which only N₂⁺ ion was used as the type of ion were prepared. In these comparative examples, the ionic acceleration voltage of each ion was also set to realize the ion injection into the central part of the magnetic film 72.

The effect of the ion injection in each of the example, the first comparative example and the second comparative example thus obtained was verified.

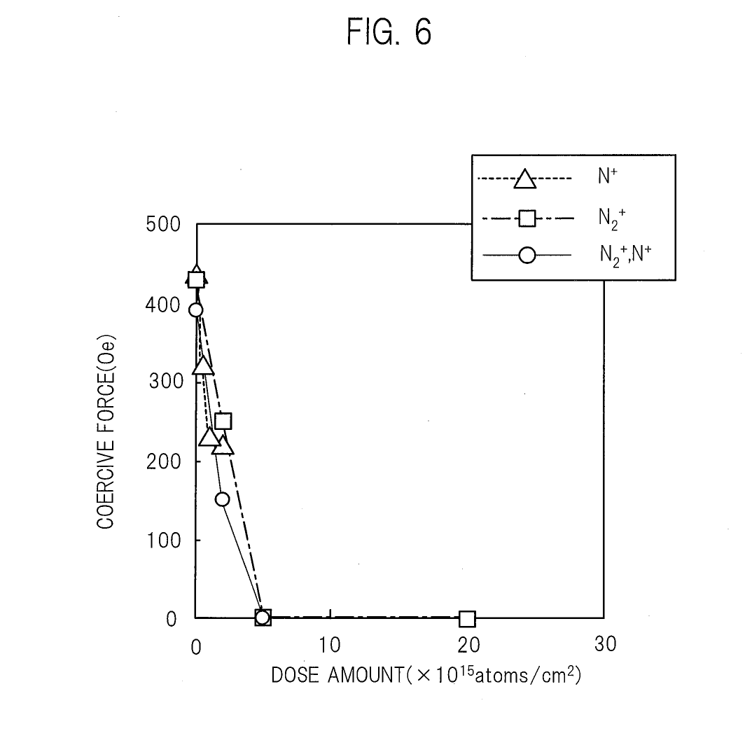

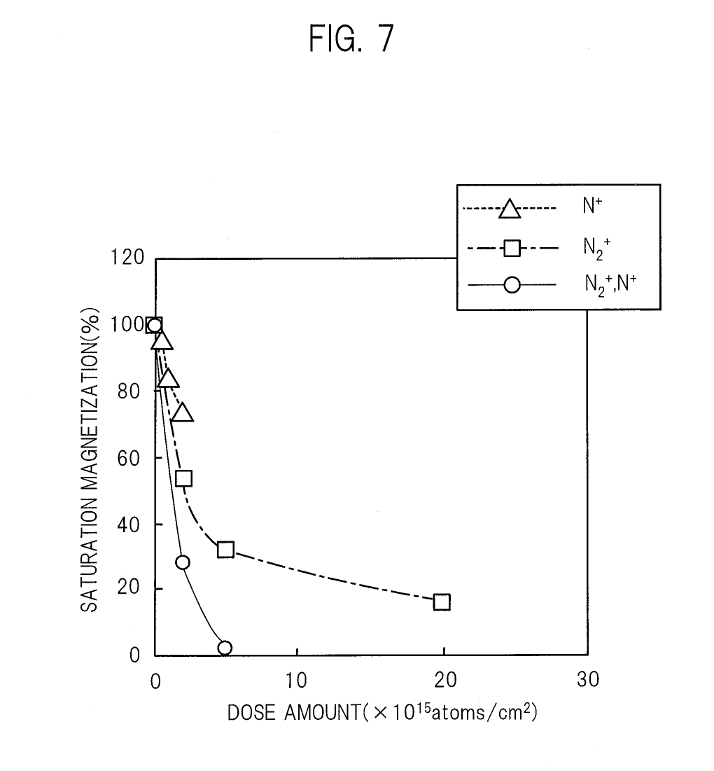

FIG. 6 and FIG. 7 are graphs each of which indicates the effect of the ion injection in each of the example, the first comparative example and the second comparative example, and the horizontal axis of FIG. 6 and FIG. 7 represents the amount of injected ions, while the vertical axis of FIG. 6 represents the coercive force and the vertical axis of FIG. 7 represents the saturation magnetization.

From FIG. 3, it is apparent that in any of the example (plotted with circular marks) and the two comparative examples (the first comparative example plotted with triangle marks, and the second comparative example plotted with square marks), the coercive force disappears when the injection amount is 5×10¹⁵/cm², and it is possible to make the perpendicular magnetic anisotropy occurring by the layered structure of the artificial lattice disappear. On the other hand, as apparent from FIG. 4, in the example (plotted with circular marks), by using the mixed ions, the saturation magnetization may be caused to completely vanish, whereas when the single ion of N⁺ or N₂⁺ is used as in the two comparative examples (the first comparative example plotted with triangle marks, and the second comparative example plotted with square marks), a larger amount of injection is necessary due to reduction in the magnetization and moreover, it was difficult to cause the saturation magnetization to completely disappear.

As indicated by these graphs, in the example, it has been able to recognize that when the amount of injected ions is 1×10¹⁵ (atoms/cm²) or more and 1×10¹⁶ (atoms/cm²) or less, both the coercive force and the saturation magnetization have disappeared. In other words, use of the above-described mixed ions has made it possible to effectively reduce the mutual magnetic interaction between the magnetic dots. Incidentally, when the amount of injected ions reaches or goes beyond 2×10¹⁶ (atoms/cm²), there is a possibility that the film thickness of the magnetic film may decrease due to the ion injection, disturbing the smoothness of the surface of the medium and thus, it is desirable that the amount of injected ions be less than 2×10¹⁶ (atoms/cm²) and preferably not more than 1×10¹⁶ (atoms/cm²).

As described above, from the comparison in the effect of the ion injection among the example, the first comparative example and the second comparative example, the mixed ions of N₂⁺ ion and N⁺ ion produce a higher effect of reducing the saturation magnetization due to the ion injection than the single ion of N⁺ or N₂⁺, and it has been able to verify that the saturation magnetization may be caused to disappear even with a small amount of injected ions. From this, it is apparent that in the method of producing the magnetic storage medium in the ion doping system, the injecting time may be shortened by using the mixed ions as the type of ion, and the magnetic storage medium may be obtained without impairing the mass productivity.

Incidentally, in the above description, use of the resist pattern as a preferable mask for forming the magnetic dots has been discussed as an example, but in the ion injection in the above-described basic modes, a process in which a stencil mask is disposed not to touch the surface of the medium and the ions are injected may be employed and in this process, the resist application and the resist removal may be omitted. Further, in the above description, use of the nano-imprint process has been stated as the best example of the patterning of the resist, but electron beam exposure may be used in the patterning.

1. A method of producing a magnetic storage medium, the method characterized by comprising:
magnetic-film-forming including forming a magnetic film on a substrate; and
between-dots-separating including reducing saturation magnetization by locally injecting mixed ions of N₂⁺ ion and N⁺ ion into an area, of the magnetic film, other than a plurality of areas which respectively become magnetic dots where information is to be magnetically recorded, to form between the magnetic dots a between-dot separator having saturation magnetization smaller than saturation magnetization of the magnetic dots.

2. The method of producing the magnetic storage medium according to claim 1, characterized by comprising:
mask-forming including forming a mask that obstructs ion injection into the magnetic dots, in the plurality of areas which respectively become the magnetic dots, in the magnetic film, wherein
the-between-dots-separating includes applying the mixed ions from above the magnetic film where the mask is formed on the plurality of areas, to locally inject the mixed ions into an area between the magnetic dots protected by the mask.

3. The method of producing the magnetic storage medium according to claim 1, characterized in that the magnetic-film-forming includes forming a magnetic film having an artificial lattice structure, by laminating plural kinds of atomic layers on the substrate alternately.

4. The method of producing the magnetic storage medium according to claim 3, characterized in that the magnetic-film-forming includes forming the magnetic film having the artificial lattice structure, by laminating a Co atomic layer and a platinum metal atomic layer alternately.

5. The method of producing the magnetic storage medium according to claim 3, characterized in that the magnetic-film-forming includes forming the magnetic film having the artificial lattice structure, by laminating a Co atomic layer and a Pd atomic layer alternately.

6. The method of producing the magnetic storage medium according to claim 2, characterized in that the mask-forming includes forming the mask with a resist.

7. The method of producing the magnetic storage medium according to claim 2, characterized in that the mask-forming includes forming the mask with a resist, by a nano-imprint process.

8. A magnetic storage medium characterized by comprising:
a substrate;
a plurality of magnetic dots which are provided on the substrate, each of which has a magnetic film and on each of which information is magnetically recorded; and
a between-dot separator that is provided between the magnetic dots, and that has a film which is structurally linked to the magnetic film of the magnetic dot continuously, into which mixed ions of N₂⁺ ion and N⁺ ion are injected and which has saturation magnetization smaller than saturation magnetization of the magnetic dot.

9. The magnetic storage medium according to claim 8, characterized in that the magnetic dot has a magnetic film having an artificial lattice structure in which plural kinds of atomic layers are laminated on the substrate alternately, and
the between-dot separator has an artificial lattice structure continuously linked to the artificial lattice structure, and into which the mixed ions are injected.

10. The magnetic storage medium according to claim 9, characterized in that the artificial lattice structure is a structure where a Co atomic layer and a platinum metal atomic layer are laminated alternately.

11. The magnetic storage medium according to claim 9, characterized in that the artificial lattice structure is a structure where a Co atomic layer and a Pd atomic layer are laminated alternately.

12. An information storage device characterized by comprising:
a magnetic storage medium including:
a substrate,
a plurality of magnetic dots which are provided on the substrate, each of which has
a magnetic film and on each of which information is magnetically recorded, and
a between-dot separator that is provided between the magnetic dots, and that has a film which is structurally linked to the magnetic film of the magnetic dot continuously, into which mixed ions of N₂⁺ ion and N⁺ ion are injected into the film and which has saturation magnetization smaller than saturation magnetization of the magnetic dot;
a magnetic head that approaches or touches the magnetic storage medium, to perform at least one of magnetically recording of information and magnetically reproducing of information for the magnetic dot; and
a head-position control system that moves the magnetic head relatively with respect to a surface of the magnetic storage medium, to position the magnetic head on the magnetic dot for which at least one of the information writing and the information reproduction is performed by the magnetic head.

13. The information storage device according to claim 12, characterized in that the magnetic dot has an artificial lattice structure in which plural kinds of atomic layers are laminated on the substrate alternately.

14. The information storage device according to claim 12, characterized in that the magnetic dot has a magnetic film having an artificial lattice structure in which plural kinds of atomic layer are laminated on the substrate alternately, and
the between-dot separator has an artificial lattice structure continuously linked to the artificial lattice structure, and into which the mixed ions are injected.

15. The information storage device according to claim 13, characterized in that the artificial lattice structure is a structure where a Co atomic layer and a Pd atomic layer are laminated alternately.
